(19) United States
(12) Patent Application Publication
(10) Pub. No.: US 2012/0243953 A1
(43) Pub. Date: Sep. 27, 2012

(54) THREAD-CUTTING SYSTEM

(75) Inventor: Georg Orberndorfer, Feldkirch (AT)

(73) Assignee: Hilti Aktiengesellschaft, Schaan (LI)

(21) Appl. No.: 13/428,088

(22) Filed: Mar. 23, 2012

(30) Foreign Application Priority Data
Mar. 24, 2011 (DE) DE 102011006015.4

(51) Int. Cl. B23G 5/20; B23G 1/50; B23B 51/08

(52) U.S. Cl. 408/1 R; 408/22

(57) ABSTRACT

A thread-cutting system, especially for cutting threads in holes drilled into concrete, including a cutting-tool set (12) with a drill bit (16) for drilling a hole and a sleeve-like thread cutter (18) that concentrically surrounds the drill bit (16) and is separate from it. The drill bit (16) projects axially beyond the thread cutter (18).

This claims the benefit of German Patent Application DE 10 2011 006 015.4, Mar. 24, 2011, and hereby incorporated by reference herein.

The invention relates to a thread-cutting system, especially for cutting threads in holes drilled into concrete.

### BACKGROUND

Such drilled holes serve to receive screws that are used for fastening objects in the substrate.

The conventional technique for setting concrete screws is to drill a hole without a thread and to screw the concrete screw into the drilled hole, a process in which the screw itself cuts the requisite counter-thread into the wall of the drilled hole. For purposes of setting the concrete screw, a tangential impact screwdriver, for example, is used with which the driving energy is transferred to the concrete screw in time-staggered pulses in the tangential direction. In order for the concrete screw to be able to cut into the concrete, the shank and the thread of the screw have to be very hard and strong. This makes it more difficult to produce and it increases the manufacturing costs. Moreover, problems can arise when a reinforcement bar is struck during the drilling, since then the concrete screw has to cut a thread into the iron, and this can cause wear and tear of the thread of the concrete screw.

### SUMMARY OF THE INVENTION

These drawbacks can be avoided if the concrete screw is screwed into a thread that has already been prepared in the drilled hole. For this purpose, after the hole has been drilled, a separate work step is normally needed in order to cut the thread, which calls for a separate tool and delays the setting procedure, thus making it more expensive.

It is an objective of the invention provide the setting of a screw, especially of a concrete screw, reliably and simply.

The present invention provides a thread-cutting system that has a cutting-tool set with a drill bit for drilling a hole and a sleeve-like thread cutter that concentrically surrounds the drill bit and is separate from it, whereby the drill bit projects axially beyond the thread cutter. With this thread-cutting system, the hole is drilled and the thread is simultaneously cut into the wall of the drilled hole in one single work step. The hole is drilled by the drill bit whose tip projects beyond the thread cutter. The thread cutter then cuts the thread into the wall of the hole that is being drilled in this way. The screw can subsequently be screwed into the prepared drilled hole, a process in which the thread of the screw engages with the already prepared thread, and the screw is not used to cut a thread into the wall of the drilled hole. Since the thread of the screw is not stressed by the setting procedure, it is ensured that the screw will retain a constant strength and load-bearing capacity.

Preferably, the drill bit tip projecting axially beyond the thread cutter is radially widened with respect to the adjacent drill bit shank so that the amount of material that has to be removed by the thread cutter is kept as small as possible.

The drill bit tip preferably has a diameter that is greater than the inner diameter of the thread cutter. This ensures that almost all of the work for drilling the hole is performed by the drill bit.

The maximum diameter of the drill bit tip advantageously corresponds approximately to the core diameter of the thread cutter, so that the shank of the thread cutter is in contact with the wall of the drilled hole and only the thread of the thread cutter penetrates into the wall of the drilled hole and cuts the thread. Preferably, the drill bit tip and the thread cutter are harmonized with to each other in such a way that the thread cutter fits almost perfectly into the hole that is drilled by the drill bit, and its shank comes into contact with the wall of the drilled hole.

In a preferred embodiment of the invention, the thread-cutting system also comprises a power drill for driving the cutting-tool set.

The power drill preferably comprises one separate tool receptacle for the drill bit and one for the thread cutter.

The drill bit and the thread cutter can be parts that are separate from each other, not joined together.

With a separate tool receptacle for the drill bit and for the thread cutter, it is possible to drive the drill bit only axially and to drive the thread cutter only with a rotational movement.

For this reason, the power drill preferably has an axial impact drive for the drill bit and/or a tangential impact drive for the thread cutter. Such a separation of the drives yields the best drilling and cutting results.

The drill bit can be driven axially and/or circumferentially, while the thread cutter is preferably only driven circumferentially, an approach that has proven its worth for thread cutting.

Thus, the impact drives can be regulated in such a way that the impact energy is applied at staggered time intervals to the drill bit (axial impact drive) and to the thread cutter (tangential impact drive), in other words, the drill bit and the thread cutter execute their impact movements in a time-staggered manner.

However, it is likewise possible for the drill bit and the thread cutter to be rotated simultaneously so as to be impact-driven.

Even though the invention is being described in conjunction with concrete screws, it can be readily transferred to all other types of screws for any desired substrates that can be provided with a thread.

### BRIEF DESCRIPTION OF THE DRAWINGS

The invention will be explained in greater detail below on the basis of an embodiment making reference to the accompanying drawings. These drawings show the following:

FIG. 1 a schematic view of a thread-cutting system according to the invention, with a tool set and with a power drill; and

FIG. 2 the tool set of the thread-cutting system from FIG. 1.

### DETAILED DESCRIPTION

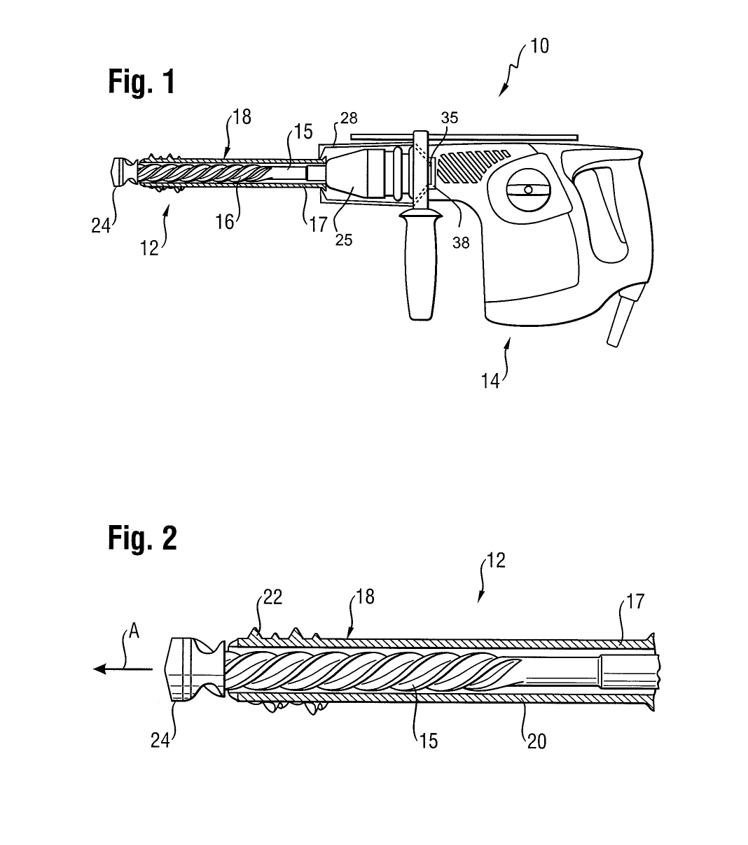

FIG. 1 shows a thread-cutting system 10 comprising a cutting-tool set 12 and a power drill 14. The power drill 14 is an electrically operated handheld device and it has an axial impact drive 35, shown schematically, that is connected to a first tool receptacle 25, and a tangential impact drive 38, also shown schematically, that is connected to a second tool receptacle 28, also shown schematically. The first tool receptacle 25 is configured to hold the shank 15 of a drill bit, while the second tool receptacle 28 is configured concentrically around the first tool receptacle so as to hold a sleeve-like tool end 17.

The cutting-tool set 12 has a drill bit 16 with a shank 15, which can be held in the first tool receptacle 25. Moreover, the cutting-tool set 12 has a thread cutter 18 that has a sleeve-like shank 20 with a tool end 17 as well as an end located in the front in the axial direction A and having a few windings of a cutting thread 22. The thread cutter 18 surrounds the drill bit 16 concentrically, whereby a tip 24 of the drill bit 16 projects axially beyond the thread cutter 18.

The diameter D of the drill bit tip 24 is larger than that of the shank 17 of the drill bit 16 and it is selected in such a way that it corresponds to the outer diameter of the shank 20 of the thread cutter 18, that is to say, it matches the core diameter of the thread cutter. In the radial extension of the cutting section of the tool set 12, only the thread 22 projects beyond the shank 20 of the thread cutter 18 and the drill bit tip 24.

The drill bit 16 and the thread cutter 18 can be driven independently of each other. These two components are not actually connected to each other if one disregards their connection via the tool receptacles of the power drill 14. The power drill 14 drives the drill bit 16 in the rotational direction and with axial impacts, while the thread cutter 18 is rotationally driven with purely tangential impacts.

It is possible to drive the drill bit 16 likewise tangentially or else with axial as well as tangential impacts.

The two impact drives 35, 38 of the power drill 14 are regulated in such a way that the impact energy is applied to the drill bit 16 and to the thread cutter 18 at staggered time intervals, whereby these drives are preferably operated alternately. However, the drives can also be regulated in such a way that the impact energy is applied simultaneously.

In order to drill a hole having a thread, for example, in concrete or in reinforced concrete, the cutting-tool set 12 is connected to the power drill 14 in such a way that the drill bit 16 is affixed in the first tool receptacle 25 while the thread cutter 18 is affixed in the second tool receptacle 28.

The drill bit 24 drills a hole with smooth walls whose diameter corresponds approximately to the outer diameter of the cylindrical shank 20 of the thread cutter 18. The thread cutter 18 is not involved in the drilling of the hole.

As the drill bit tip 24 penetrates further into the substrate, the thread 22 of the thread cutter 18 cuts into the wall of the drilled hole, thus creating a thread.

Once the hole has been drilled to the desired depth, the cutting-tool set is taken out of the drilled hole under rotation in the opposite direction.

After completion of the drilling work and after the cutting-tool set 12 has been taken out, a screw, for instance, a concrete screw, is inserted into the drilled hole in that it is screwed into the thread that has been cut into the wall by the thread cutter 18.

What is claimed is:

1. A thread-cutting system comprising:
a cutting-tool set with a drill bit for drilling a hole and a sleeve-like thread cutter concentrically surrounding the drill bit and separate from the drill bit, the drill bit projecting axially beyond the thread cutter.

2. The thread-cutting system as recited in claim 1 wherein the drill bit has a tip projecting axially beyond the thread cutter and radially widened with respect to the adjacent drill bit shank.

3. The thread-cutting system as recited in claim 2 wherein the drill bit tip has a diameter greater than the inner diameter of the thread cutter.

4. The thread-cutting system as recited in claim 1 further comprising a power drill for driving the cutting-tool set.

5. The thread-cutting system as recited in claim 4 wherein the power drill comprises a first tool receptacle for the drill bit and a second separate tool receptacle for the thread cutter.

6. The thread-cutting system as recited in claim 4 wherein the power drill has at least one of an axial impact drive for the drill bit and a tangential impact drive for the thread cutter.

7. The thread-cutting system as recited in claim 6 wherein the axial and tangential impact drives are regulated in such a way that the impact energy is applied at staggered time intervals to the drill bit and to the thread cutter.

8. The thread-cutting system as recited in claim 4 wherein the power drill and/or the cutting-tool set are designed in such a way that the drill bit is driven axially and/or circumferentially, while the thread cutter is only driven circumferentially.

9. The thread-cutting system as recited in claim 1 wherein the system is a concrete thread-cutting system.

10. A method for cutting threads comprising:
cutting threads in concrete using the thread-cutting system as recited in claim 1.

11. A method for cutting threads comprising:
cutting threads using the thread-cutting system and/or power drill as recited in claim 4 by driving the drill bit axially and/or circumferentially, while the thread cutter is driven solely circumferentially.

12. A method for cutting threads comprising:
cutting threads using the thread cutting system as recited in claim 6 by regulating the axial and tangential impact drives so that impact energy is applied at staggered time intervals to the drill bit and to the thread cutter.
